(19) United States
(12) Patent Application Publication
(10) Pub. No.: US 2023/0091765 A1
(43) Pub. Date: Mar. 23, 2023

(54) Motor Vehicle

(71) Applicant: Bayerische Motoren Werke Aktiengesellschaft, Muenchen (DE)

(72) Inventors: Dominic HAGL, Erding (DE); Abdelmalek HANAFI, Muenchen (DE); Joerg KAELBLE, Muenchen (DE); Julia LINDHUBER, Muenchen (DE); Peter REICHLE, Olching (DE)

(21) Appl. No.: 17/908,038

(22) PCT Filed: May 20, 2021
(86) PCT No.: PCT/EP2021/063550

§ 371 Date: Aug. 30, 2022

(30) Foreign Application Priority Data
May 28, 2020 (DE) 10 2020 114 257.9

(51) Int. Cl. B60Q 1/26; B60Q 1/28; B60R 19/52; F21S 43/237; F21S 43/245

(52) U.S. Cl. CPC B60Q 1/2661; B60Q 1/28; B60R 19/52; F21S 43/237; F21S 43/245; B60R 2019/525

(57) ABSTRACT

A motor vehicle includes a radiator grille and a lighting apparatus with a number of light sources. During operation, the lighting apparatus emits light, which originates from the number of light sources, from the radiator grille into the surrounds of the motor vehicle. The lighting apparatus includes a number of flexible fiber bundles. Each fiber contains one or more fibers and has a homogeneous outer surface for generating homogeneous light radiation in a circumferential direction of the fiber bundle. Further, each fiber bundle is arranged at least in sections on the radiator grille and coupled to at least one light source at at least one light one fiber bundle end, the light source feeding into the at least one fiber bundle end during operation.

### BACKGROUND AND SUMMARY OF THE INVENTION

The invention relates to a motor vehicle having a radiator grill.

It is known from the prior art to integrate lighting into the radiator grill of a motor vehicle.

Printed publication DE 10 2016 203 964 A1 discloses a motor vehicle having a radiator grill which comprises a plurality of luminous bodies spaced apart from one another. The luminous bodies are respectively preceded in the driving direction by an aperture. The light of a respective luminous body is reflected by an assigned reflector unit so that light is emitted outward from the motor vehicle through the radiator grill. The luminous bodies may, for example, be configured as light guides.

Printed publication DE 10 2012 009 291 A1 discloses a motor vehicle in which frame sections in the region of the radiator grill are configured as light guides.

It is an object of the invention to provide a motor vehicle having a radiator grill, from which light is emitted by way of a different lighting device than in the prior art.

This object is achieved by the claimed invention.

The motor vehicle according to an embodiment of the invention, which may preferably be configured as an automobile but optionally also as a truck, comprises a radiator grill which, in a manner known per se, is installed in the front of the motor vehicle. A lighting device having a number of light sources (i.e. having at least one light source) is furthermore provided in the motor vehicle, and the lighting device is configured in such a way that, during operation, it emits light which comes from the number of light sources from the radiator grill into the exterior of the motor vehicle.

The motor vehicle according to an embodiment of the invention is distinguished in that the lighting device comprises a number of flexible fiber bundles (i.e. at least one fiber bundle). A respective flexible fiber bundle is in this case purposely configured in such a way that it can be bent without damage at least up to a particular minimum radius of curvature. Each fiber bundle contains one or more fibers and preferably a plurality of fibers. Nevertheless, here and in what follows the term fiber bundle also covers an individual fiber. The fiber or fibers and the fiber bundle preferably have a round cross section.

Each fiber bundle furthermore has a homogeneous outer face for generating substantially homogeneous light radiation in the circumferential direction of the fiber bundle. In other words, a homogeneous luminance of the light emitted by the fiber bundle is achieved along its circumference for any arbitrary position along its longitudinal extent. In one preferred configuration, a suitable fiber bundle or corresponding light sources with high light intensity ensure that the light emission is also substantially homogeneous in the longitudinal direction of the fiber bundle.

In the motor vehicle according to an embodiment of the invention, each fiber bundle is arranged at least in sections on the radiator grill and is coupled at at least one fiber bundle end to at least one light source of the number of light sources. The at least one light source feeds light into the at least one fiber bundle end during operation.

The motor vehicle according to an embodiment of the invention is distinguished in that fiber bundles for light emission are used for the first time in a radiator grill. In contrast to a light guide which has dedicated output coupling structures in its outer face, a fiber bundle allows homogeneous light emission because of its homogeneous outer face. In this way, the fiber bundle is visible from different viewing angles. In contrast to conventional rigid light guides, the fiber bundle installed in the motor vehicle according to an embodiment of the invention is flexible, whereby its incorporation in the radiator grill is simplified.

In one preferred variant of the motor vehicle according to the invention, a respective fiber bundle of at least some of the number of fiber bundles (preferably each fiber bundle present) runs for at least a part of its longitudinal extent along an outer contour of the radiator grill. In this way, the outer contour of the radiator grill is highlighted by the light radiation of the fiber bundle. Here and in what follows, the term “at least some of the number of fiber bundles” refers to a single fiber bundle if only one fiber bundle is provided or at least one fiber bundle if more than one fiber bundle is provided.

In another preferred configuration, a plurality of fiber bundles which respectively run along a different section of the outer contour of the radiator grill for at least a part of their longitudinal extent are arranged on the radiator grill.

In another preferred configuration, a fiber bundle which runs around the entire outer contour of the radiator grill for at least a part of its longitudinal extent is provided. Preferably, this fiber bundle is the only fiber bundle provided on the radiator grill.

In another preferred variant, a respective fiber bundle of at least some of the number of fiber bundles, and preferably each fiber bundle present, is covered at least in sections by a frame structure which is placed onto the radiator grill and at least in sections is translucent for the light radiation of the respective fiber bundle. In this way, suitable protection of the fiber bundle from external influences is achieved. Preferably, the frame structure runs along an outer contour of the radiator grill. Furthermore, the frame structure preferably consists of a single frame element, whereby the assembly of the radiator grill and the frame structure is simplified. Nevertheless, the frame structure may optionally also contain a plurality of frame elements.

Depending on the configuration, a respective fiber bundle may be fastened differently in the radiator grill. Preferably, a respective fiber bundle of at least some of the number of fiber bundles, and in particular each fiber bundle present, is clamped and/or adhesively bonded and/or clipped in the radiator grill. These types of fastening are known per se. In the case of clipping, a suitable latch mechanism, by which the clipping in the radiator grill is carried out, is provided.

In another configuration, a respective fiber bundle of at least some of the number of fiber bundles, and preferably each fiber bundle, has a strip which extends in the longitudinal direction of the respective fiber bundle along its outer face and by way of which the respective fiber bundle is fastened in the radiator grill. Such strips are known per se and are often referred to as keder strips.

Depending on the configuration, the number of light sources may be based on different technologies. Preferably, the number of light sources comprises one or more laser diodes, whereby sufficiently bright light emission of the corresponding fiber bundles is ensured. Nevertheless, as an alternative or in addition, it is also possible for the number of light sources to comprise one or more LEDs.

In another preferred configuration, at least one light source of the number of light sources is arranged in at least one headlamp (i.e. at least one front headlamp) which is positioned adjacent to the radiator grill. The effect achieved by this is that the corresponding light sources are relocated from the very tight installation space of the radiator grill into the headlamp housing.

In another preferred configuration, for a respective fiber bundle of at least some of the number of fiber bundles, and preferably for each fiber bundle present, an optical jack for the releasable connection of two sections of the respective fiber bundle is provided. Preferably, this optical jack is arranged outside the radiator grill in a plan view of the radiator grill and/or it is arranged adjacent to a light source which is coupled to the respective fiber bundle in order to supply light. With this variant of the invention, simple replacement of the fiber bundle and of the light source independently of one another can be achieved by separating the fiber bundle by way of the optical jack.

In the motor vehicle according to an embodiment of the invention, fiber bundles known per se may be installed in its radiator grill. In one preferred variant, a respective fiber bundle of at least some of the number of fiber bundles, and in particular each fiber bundle present, comprises one or more glass fibers and/or one or more plastic fibers. In another preferred embodiment, a respective fiber bundle of at least some of the number of fiber bundles, and preferably each fiber bundle present, has a round cross section with a diameter between 0.5 mm and 2 mm, preferably less than 1.3 mm.

The number of fibers per fiber bundle may be selected differently. Preferably, a respective fiber bundle of at least some of the number of fiber bundles, and in particular each fiber bundle installed, contains between 50 and 700 fibers. In another preferred variant, the outer face of a respective fiber bundle of at least some of the number of fiber bundles, and preferably the outer face of each fiber bundle installed, is formed from a coating, preferably of fluorinated polymer. In this way, the homogeneity of the outer face is ensured in a straightforward manner.

An exemplary embodiment of the invention will be described in more detail below with the aid of the appended figures.

### BRIEF DESCRIPTION OF THE DRAWINGS

FIG. 1 shows an exploded representation of a part of a bumper having a radiator grill and a lighting device in one variant of the motor vehicle according to an embodiment of the invention.

FIG. 2 to FIG. 4 show plan views of the frame structure of FIG. 1, which show various configurations of lighting devices according to different embodiments of the motor vehicle according to the invention.

FIG. 5 shows a cross section along a vertical plane, running in the driving direction, through the lighting device of FIG. 1.

### DETAILED DESCRIPTION OF THE DRAWINGS

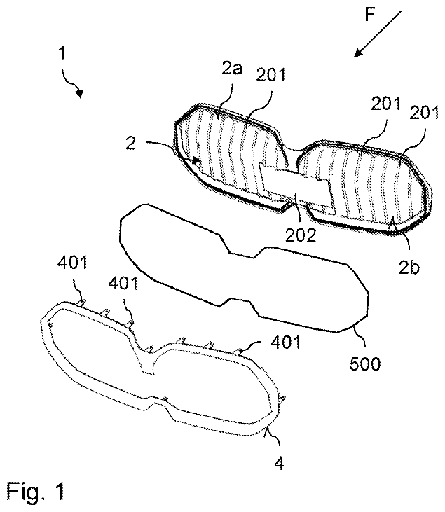

FIG. 1 shows a perspective exploded representation of a section of a front bumper 1, which is installed in a variant of a motor vehicle according to the invention. In FIG. 1, a central front region of the bumper with a radiator grill 2 integrated therein is in this case shown. The driving direction of the motor vehicle is indicated for illustration by the arrow F.

The radiator grill 2 comprises a left subregion 2a and a right subregion 2b, which are often also referred to as kidneys and are joined together in the middle of the radiator grill through a narrowed section. In a manner known per se, the radiator grill comprises a plurality of ribs 201 extending in the vertical direction, only some of which are denoted by this reference sign. A plate 202, which covers sensors installed in the radiator grill, is furthermore provided in the front region of the radiator grill.

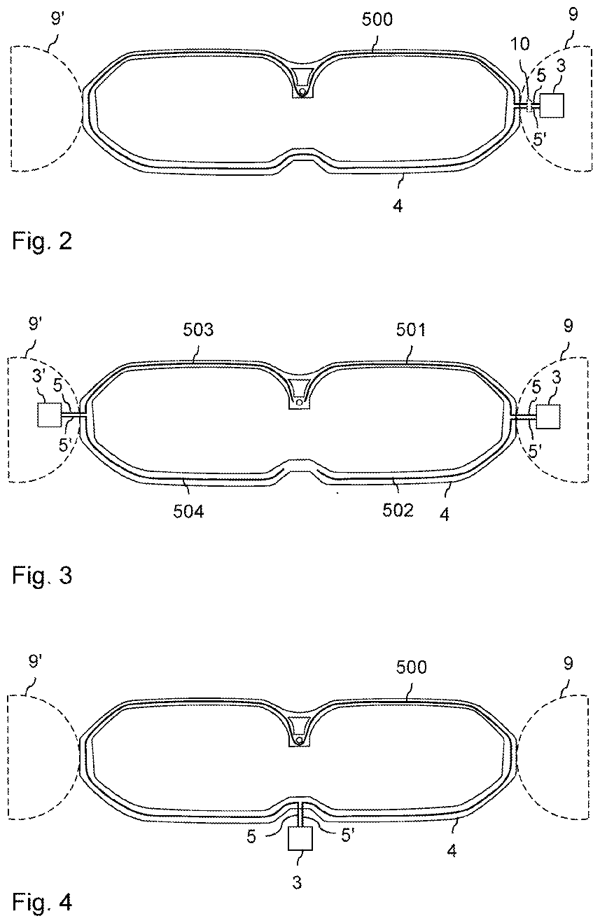

In order to achieve elegant illumination of the outer contour of the radiator grill 2, a fiber bundle is used, a continuous fiber bundle 500 which runs around the entire outer contour of the radiator grill 2 being used in the embodiment of FIG. 1. As may be seen from FIG. 2, which is described below, light of a laser light source 3, which is installed in the headlamp 9 adjacent to the subsection 2b of the radiator grill 2, is fed into corresponding fiber bundle ends 5, 5′ of the fiber bundle 500. For reasons of clarity, neither the fiber bundle ends nor the headlamp with the laser light source installed therein are shown in FIG. 1.

In the embodiment described here, a glass fiber bundle having a plurality of glass fibers twisted with one another is used as the fiber bundle 500. In one particular variant, the fiber bundle has 96 fibers with a respective fiber diameter of about 50 μm. Compared with a conventional light guide, a fiber bundle is distinguished in that it does not have an output coupling structure but instead a homogeneous outer face, so that it emits homogeneous light with a uniform luminance in the circumferential direction. Preferably, the light emission is also substantially homogeneous along the longitudinal extent of the fiber bundle, which may be ensured by supplying light with high intensity by way of a laser light source.

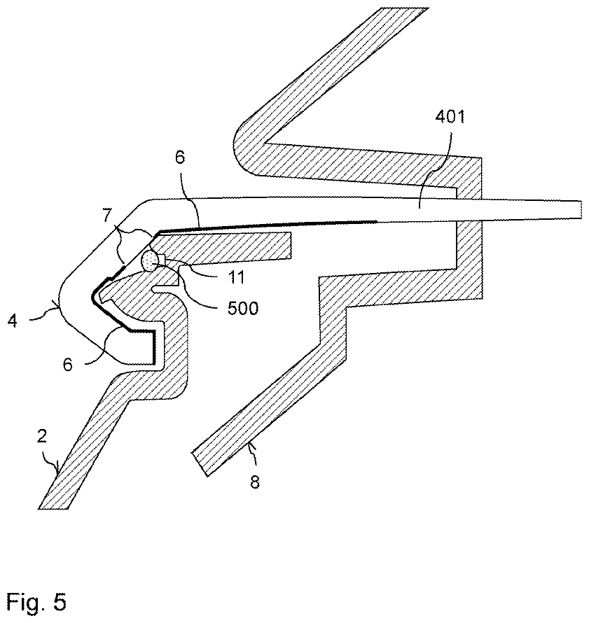

In the variant described here, the fiber bundle 500 is held in the radiator grill 2 by clamping, as will be described below with the aid of FIG. 5. Furthermore, the fiber bundle 500 is covered by a frame structure in the form of a frame element 4. The frame element comprises a plurality of lugs 401, only some of which are denoted with this reference sign in FIG. 1 and with which the frame element 4 is fastened on a body component, as will likewise be explained below with the aid of FIG. 5. The frame element 4 consists of diffuse translucent material which is partially coated. In the region of the frame element which lies in front of the fiber bundle 500, there is however no coating so that light of the fiber bundle 500 can emerge outward there and the effect of a luminous outer contour of the radiator grill 2 can thereby be generated.

The shape of the radiator grill as described above is merely exemplary. In particular, the radiator grill may optionally also consist of two mutually separated subregions in the form of separated kidneys. In this case, a separate frame element, which in turn covers a fiber bundle that runs around the contour of the respective kidney, is provided for each kidney.

FIG. 2 shows a plan view from the front of the frame element 4 of FIG. 1 with the fiber bundle 500 lying behind it. The headlamps 9 and 9′ arranged adjacent to the radiator grill are also schematically indicated by dashed semicircles in FIG. 2, as well as in the further FIGS. 3 and 4. The actual shape of the headlamps differs from semicircles. The laser light source 3, which uses a laser diode for the light emission, can furthermore be seen in FIG. 2. This laser light source is indicated merely schematically by a square. The laser light source 3 is installed in the headlamp 9, i.e. it is integrated in the headlamp housing of this headlamp. This has the advantage that the laser light source is arranged outside the tight installation space of the radiator grill. The laser diode of the laser light source is enclosed by a box, so that laser light cannot emerge other than by way of the corresponding fiber bundle ends 5 and 5′.

The laser light source 3 generates white light. Preferably, a blue laser diode, the light of which is converted into white light by a conversion layer in the form of a phosphor, is used for this purpose. This white light is coupled into the fiber bundle 500 by way of the two fiber bundle ends 5 and 5′. The light coupled in propagates along the entire fiber bundle 500 and is therefore emitted substantially homogeneously from the fiber bundle along the entire outer contour of the radiator grill 2. In this way, a highly elegant light effect in the form of a luminous outer contour of the radiator grill is achieved.

In FIG. 2, an optional optical jack 10, which is arranged adjacent to the fiber bundle ends 5 and 5′, is furthermore indicated by a dashed rectangle. By way of this optical jack, the portion of the fiber bundle 500 which runs in the radiator grill 2 can be separated from the laser light source 3. In this way, simple replacement of the fiber bundle or of the laser light source may be achieved.

FIG. 3 shows a modified embodiment of the radiator grill lighting of FIG. 2. In this case, the same frame element 4 is used as in FIG. 1, although instead of a continuous fiber bundle 500, four separate fiber bundles 501, 502, 503 and 504 are used, which respectively run along a section of the frame element 4 and therefore of the outer contour of the radiator grill 2. Furthermore, two laser light sources 3 and 3′ are provided, the laser light source 3 being installed in the headlamp 9 and the light source 3′ being installed in the headlamp 9′.

According to FIG. 3, the fiber bundle 501 runs in the upper section of the frame element 4 adjacent to the headlamp 9 and is supplied by the laser light source 3 by way of the fiber bundle end 5. Correspondingly, the fiber bundle 502 is arranged in the lower section of the frame element 4 adjacent to the headlamp 9 and is supplied by the laser light source 3 at its fiber bundle end 5′. Conversely, the fiber bundle 503 is arranged in an upper section of the frame element 4 adjacent to the headlamp 9′ and is supplied by the laser light source 3′ at its fiber bundle end 5. Similarly, the fiber bundle 504 is arranged in the lower section of the frame element 4 adjacent to the headlamp 9′ and is supplied by the laser light source 3′ at its fiber bundle end 5′.

With the embodiment just described, particularly bright illumination of the outer contour of the radiator grill 2 can be achieved by using two laser light sources. In analogy with FIG. 2, corresponding optical jacks for separating the fiber bundles from the laser light source may be provided at the laser light source 3 or 3′, respectively, in the embodiment of FIG. 3 as well as of FIG. 4, which is described below.

FIG. 4 shows another modified embodiment of radiator grill lighting. This variant corresponds substantially to the embodiment of FIG. 2, with the difference that the laser light source 3 is now installed not in the headlamp 9 but below the radiator grill 2. From there, in a similar way as in the variant of FIG. 2, the light of the laser light source 3 is fed by way of fiber bundle ends 5 and 5′ to a single fiber bundle 500 which runs around the entire frame element 4 and therefore the entire outer contour of the radiator grill.

FIG. 5 shows a cross-sectional view of a section of the representation of FIG. 1. The section in this case runs in the vertical direction and parallel to the driving direction F along an upper lug 401 of the frame element 4, the frame element being placed on the radiator grill and the fiber bundle 500 being located behind the frame element. In FIG. 5, an upper section of the radiator grill 2 and a body component 8 lying behind it are indicated by hatching. As may be seen, the lug 401 of the frame element 4 extends into the body component 8 and is held there by a suitable fastener. This is not shown in further detail.

Furthermore, it may be seen from FIG. 5 that a groove 11 is provided in the upper region of the radiator grill 2. This groove extends along the entire outer contour of the radiator grill and is used to clamp the fiber bundle 500, which is pressed into the groove 11. Optionally, the fiber bundle 500 may be fastened on the radiator grill 2 with additional or other fastening methods. For example, the fiber bundle may be adhesively bonded on the radiator grill. Likewise, the fiber bundle may be clipped at particular positions along the outer contour of the radiator grill, in which case this clipping may be achieved with a latch known per se. In another variant, a so-called keder strip extends along the outer face of the fiber bundle 500, and this is then latched or clipped in the radiator grill using a suitable latch.

It may furthermore be seen in FIG. 5 that the inner side of the frame element 4 has a coating 6, which is opaque, in a subregion. This may, for example, be a black vapor deposit. In order to allow exit of light of the light emitted by the fiber bundle 500, an uncoated section 7 which lies adjacent to the fiber bundle 500 and which extends along the longitudinal direction of the fiber bundle around the outer contour of the radiator grill 2, is provided on the inner side of the frame element 4. At this uncoated section, the light of the fiber bundle 500 can emerge through the diffuse, translucent material of the frame element 4. By arranging the frame element 4 in front of the fiber bundle 500, suitable protection of the fiber bundle from damage during driving of the motor vehicle is achieved. In one preferred variant, a further transparent protective coating for protecting the frame element 4 is provided on the outer side of the latter.

The embodiments described above have a number of advantages. In particular, homogeneous light emission in the region of the radiator grill, and in particular on its outer contour, is achieved in a straightforward manner by way of a fiber bundle. In this case, the corresponding light source for feeding light into the fiber bundle may optionally be arranged outside the radiator grill. Preferably, a respective light source is installed in a corresponding headlamp adjacent to the radiator grill. This takes into account the fact that the installation space in the radiator grill is often limited, since a plurality of sensors are in general already integrated there. In one preferred variant, furthermore, an optical jack may also be provided, by way of which the fiber bundle can be separated, whereby changing of the corresponding light source or of the corresponding fiber bundle is facilitated.

### LIST OF REFERENCES SIGNS

1 bumper
2 radiator grill
2a, 2b subsections of the radiator grill
201 ribs of the radiator grill
202 plate of the radiator grill
3, 3′ light sources
4 frame structure
401 lugs of the frame structure
500, 501, 502, 503, 504 fiber bundles
5, 5′ fiber bundle ends
6 coating
7 uncoated section
8 body component
9, 9′ headlamps
10 optical jack
11 groove
F driving direction

1-15. (canceled)

16. A motor vehicle comprising:
a radiator grill; and
a lighting device comprising:
a plurality of light sources, wherein the lighting device is configured such that, during operation, the lighting device emits light which comes from the plurality of light sources from the radiator grill into an exterior of the motor vehicle, and
a plurality of flexible fiber bundles, wherein each fiber bundle contains one or more fibers, has a homogeneous outer face for generating homogeneous light radiation in a circumferential direction of the fiber bundle, is arranged at least in sections on the radiator grill, and is coupled at least one fiber bundle end to at least one light source, which feeds light into the at least one fiber bundle end during operation.

17. The motor vehicle according to claim 16, wherein a first respective fiber bundle of the plurality of fiber bundles runs for at least a part of its longitudinal extent along an outer contour of the radiator grill.

18. The motor vehicle according to claim 17, wherein a portion of the plurality of fiber bundles respectively run along a different section of the outer contour of the radiator grill for at least a part of their longitudinal extent.

19. The motor vehicle according to claim 17, wherein a second respective fiber bundle of the plurality of the bundles runs around the entirety of the contour of the radiator grill for at least a part of its longitudinal extent.

20. The motor vehicle according to claim 16, wherein a respective fiber bundle of the plurality of fiber bundles is covered at least in sections by a frame structure which is arranged on the radiator grill and at least in sections is translucent for the light radiation of the respective fiber bundle.

21. The motor vehicle according to claim 20, wherein the frame structure runs along an outer contour of the radiator grill.

22. The motor vehicle according to claim 20, wherein the frame structure consists of a single frame element or of a plurality of frame elements.

23. The motor vehicle according to claim 16, wherein a respective fiber bundle of the plurality of fiber bundles is at least one of clamped, adhesively bonded, or clipped in the radiator grill.

24. The motor vehicle according to claim 16, wherein a respective fiber bundle of the plurality of fiber bundles has a strip which extends in a longitudinal direction of the respective fiber bundle along its outer face and by way of which the respective fiber bundle is fastened in the radiator grill.

25. The motor vehicle according to claim 16, wherein the plurality of light sources comprises one or more LEDs and/or one or more laser diodes.

26. The motor vehicle according to claim 16, wherein at least one light source of the plurality of light sources is arranged in at least one headlamp which is positioned adjacent to the radiator grill.

27. The motor vehicle according to claim 16, wherein, for a respective fiber bundle of the plurality of fiber bundles, an optical jack for releasable connection of two sections of the respective fiber bundle is provided.

28. The motor vehicle according to claim 27, wherein the optical jack is arranged outside the radiator grill in a plan view of the radiator grill and/or the optical jack is arranged adjacent to a light source which is coupled to the respective fiber bundle in order to supply light.

29. The motor vehicle according to claim 16, wherein a respective fiber bundle of the plurality of fiber bundles comprises one or more glass fibers and/or one or more plastic fibers.

30. The motor vehicle according to claim 16, wherein a respective fiber bundle of the plurality of fiber bundles has a round cross section with a diameter between 0.5 mm and 2 mm.

31. The motor vehicle according to claim 30, wherein the diameter is less than 1.3 mm.

32. The motor vehicle according to claim 16, wherein a respective fiber bundle of at least some of the plurality of fiber bundles contains between 50 and 700 fibers.

33. The motor vehicle according to claim 16, wherein the outer face of a respective fiber bundle of the plurality of fiber bundles is formed from a coating.

34. The motor vehicle according to claim 33, wherein the coating is a fluorinated polymer.
